(19) United States
(12) Patent Application Publication
(10) Pub. No.: US 2009/0226726 A1
(43) Pub. Date: Sep. 10, 2009

(54) Surface-modified nanoparticles from aluminum oxide and oxides of the elements of the first and second main group of the periodic system, and the production thereof

(76) Inventors: Norbert Roesch, Gersthofen (DE); Ernst Krendlinger, Friedberg (DE); Anja Heinze, Meitingen/Erlingen (DE); Karl Zeisberger, Gersthofen (DE); Peter Klug, Grossostheim (DE); Waltraud Simsch, Kelkheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/990,584

(22) PCT Filed: Aug. 16, 2006
(86) PCT No.: PCT/EP2006/008067

§ 371 Date: Apr. 27, 2009

(30) Foreign Application Priority Data
Aug. 18, 2005 (DE) 10 2005 039 435.3
Aug. 18, 2005 (DE) 10 2005 039 436.1
Mar. 17, 2006 (DE) 10 2006 012 319.0
Apr. 29, 2006 (DE) 10 2006 020 516.2

(51) Int. Cl. B32B 5/16; B05D 3/12; B32B 9/04

(52) U.S. Cl. 428/405; 427/290; 428/403

(57) ABSTRACT

The invention relates to mixed oxide nanoparticles from aluminum oxide or oxides of the elements of the first and second main group of the periodic system. These mixed oxide nanoparticles are surface-modified with a coating agent, preferably a silane or siloxane.

Surface-modified nanoparticles from aluminum oxide and oxides of elements of the first and second main group of the Periodic System and the production thereof

The present invention relates to surface-modified nanoparticles and also their production, with the nanoparticles comprising Al₂O₃ together with proportions of oxides of elements of main groups I and II of the Periodic Table.

Fine aluminum oxide powders are used, in particular, for ceramic applications, for matrix reinforcement of organic or metallic layers, as fillers, polishing powders, for the production of abrasives, as additives in surface coatings and laminates and for further specific applications. For use in laminates, the aluminum oxide powders are frequently surface-modified by means of silanes in order to achieve better adaptation to the resin layers. Here, both the adhesion and the optical properties are improved. This is then reflected in a decrease in clouding. A silane-modified pyrogenic aluminum oxide for use in toners is also known (DE 42 02 694).

Nanoparticles which are composed of Al₂O₃ and whose surface has been modified by means of silanes are described in WO 02/051376. The production of these starts out from a commercial Al₂O₃ which is then treated with a silane. Production of the nanoparticles and modification of these are thus carried out in two separate steps. Commercial nanosize α-alumina (α-Al₂O₃) is in the form of a powder. However, due to the high surface energy, nanoparticles are always agglomerated to form larger agglomerates, so that in reality the powders are not composed of genuine nanoparticles. The silane-coated particles according to WO 02/051 376 are also of a corresponding size.

EP 1 123 354 (IOM Leipzig) describes polymerizable metal oxide particles which have been modified by means of various compounds bearing a reactive, functional group. Silanes are possible, inter alia, as such modifying compounds. Metal oxide particles used here are exclusively oxides of a metal or semimetal of the third to sixth main groups, the first to eighth transition groups of the Periodic Table or the lanthanides, but mixed oxides having a proportion of oxides of the first and second main groups are not described.

WO 2004/069 400 (InM Saarbrücken) describes a process for producing a functional colloid in which particles are mechanically reactively comminuted in a dispersion medium in the presence of a modifying agent so that the modifying agent is at least partly chemically bound to the comminuted colloid particles. This process starts out from homogeneous particles; the deagglomeration of agglomerates composed of existing nanoparticles is not disclosed.

U.S. Pat. No. 6,896,958 B1 (Nanophase) describes a process in which nanocrystalline materials from the group of ceramic and metallic materials are dispersed in a solvent and admixed with siloxanes. The dispersions obtained are used in crosslinkable resins to improve the scratch resistance.

It has now surprisingly been found that surface-modified nanoparticles in the form of mixed oxides comprising Al₂O₃ with a content of oxides of the elements of the first and second main groups of the Periodic Table can be produced particularly easily by deagglomeration of agglomerates of these mixed oxides in a solvent with addition of a coating agent. As coating agents, preference is given to using silanes or siloxanes.

The invention provides surface-modified nanoparticles comprising 50-99.9% by weight of aluminum oxide and 0.1-50% by weight of oxides of elements of main groups I and II of the Periodic Table, wherein the surface of these nanoparticles is modified by means of a coating agent. The aluminum oxide in these mixed oxides is preferably predominantly present in the rhombohedral α modification (α-alumina). The mixed oxides according to the present invention preferably have a crystallite size of less than 1 μm, more preferably less than 0.2 μm and particularly preferably from 0.001 to 0.09 μm. Particles according to the invention having a size of this order will hereinafter be referred to as mixed oxide nanoparticles. The mixed oxide nanoparticles of the invention can be produced by various processes described below. These process descriptions are based on the production of only pure aluminum oxide particles, but it goes without saying that in all these process variants, starting compounds of elements of main group I or II of the Periodic Table have to be present in addition to Al-containing starting compounds in order to form the mixed oxides of the invention. Preferred compounds here are, in particular, the chlorides, but the oxides, oxychlorides, carbonates, sulfates or other suitable salts are also possible. The amount of such oxide formers is calculated so that the finished nanoparticles contain the abovementioned amounts of oxide MeO.

Quite generally, the production of the nanoparticles of the invention starts at from larger agglomerates of these mixed oxides which are subsequently deagglomerated to the desired particle size. These agglomerates can be produced by processes described below.

Such agglomerates can be produced, for example, by means of various chemical syntheses. These are usually precipitation reactions (hydroxide precipitation, hydrolysis of metal-organic compounds) with subsequent calcination. Crystallization nuclei are frequently added in order to reduce the transformation temperature to α-aluminum oxide. The sols obtained in this way are dried and thus converted into a gel. Further calcination then takes place at temperatures in the range from 350° C. to 650° C. To bring about the transformation into α-Al₂O₃, ignition at temperatures of about 1000° C. then has to be carried out. The processes are comprehensively described in DE 199 22 492.

A further route is the aerosol process. Here, the desired molecules are obtained from chemical reactions of a precursor gas or by rapid cooling of a supersaturated gas. The formation of particles occurs either by collision or the continual vaporization and condensation of clusters of molecules which take place in equilibrium. The newly formed particles grow as a result of further collision with product molecules (condensation) and/or particles (coagulation). If the coagulation rate is greater than the rate of new formation or growth, agglomerates of spherical primary particles are formed.

Flame reactors represent a production variant based on this principle. Here, nanoparticles are formed by decomposition of precursor molecules in the flame at 1500° C.-2500° C. Examples which may be mentioned are the oxidations of TiCl₄; SICl₄ and Si₂O(CH₃)₆ in methane/O₂ flames, which lead to TiO₂ and SiO₂ particles. When AlCl₃ was used, only the corresponding alumina could hitherto be produced. Flame reactors are nowadays used industrially for the synthesis of submicro particles such as carbon black, pigment TiO₂, silica and alumina.

Small particles can also be formed from droplets by means of centrifugal force, compressed air, sound, ultrasound and further methods. The droplets are then converted into powder by direct pyrolysis or by means of in-situ reactions with other gases. Known processes which may be mentioned are spray drying and freeze drying. In spray pyrolysis, precursor droplets are transported through a high-temperature field (flame, furnace) which leads to rapid vaporization of the volatile component or initiates the decomposition reaction to the desired product. The desired particles are collected in filters. An example which may be mentioned here is the preparation of BaTiO₃ from an aqueous solution of barium acetate and titanium lactate.

Milling can likewise be used to try to comminute α-alumina and thus produce crystallites in the nanosize range. The best milling results can be achieved in wet milling using stirred ball mills. Here, milling media composed of a material which is harder than α-alumina have to be used.

A further way of preparing α-alumina at low temperature is the conversion of aluminum chlorohydrate. For this purpose, the aluminum chlorohydrate is likewise admixed with inoculation nuclei, preferably of very fine α-alumina or hematite. To avoid crystal growth, the samples have to be calcined at temperatures of about 700° C. up to a maximum of 900° C. The calcination time is at least four hours. Disadvantages of this method are therefore the large time outlay and the residual amounts of chlorine in the aluminum oxide. This method has been comprehensively described in Ber. DKG 74 (1997) No. 11/12, pp. 719-722.

The nanoparticles have to be set free from these agglomerates. This is preferably achieved by milling or by treatment with ultrasound. According to the invention, this deagglomeration is carried out in the presence of a solvent and a coating agent, preferably a silane, which during the milling process saturates the resulting active and reactive surfaces by chemical reaction or physical attachment and thus prevents reagglomeration. The nanosize mixed oxide remains in the form of small particles. It is also possible to add the coating agent after deagglomeration has been effected.

The production according to the invention of the mixed oxides preferably starts out from agglomerates which are produced as described in Ber. DKG 74 (1997) No. 11/12, pp. 719-722, as cited above.

The starting point here is aluminum chlorohydrate of the formula Al₂(OH)ₓCl_{y}, where x is from 2.5 to 5.5 and y is from 3.5 to 0.5 and the sum of x and y is always 6. This aluminum chlorohydrate is mixed as aqueous solution with crystallization nuclei, subsequently dried and then subjected to heat treatment (calcination).

The synthesis starts out from about 50% strength aqueous solutions as are commercially available. Such a solution is admixed with crystallization nuclei which promote the formation of the a modification of Al₂O₃. In particular, such nuclei bring about a reduction in the temperature for the formation of the α modification in the subsequent heat treatment. Preferred nuclei are very finely divided α-alumina, diaspore or hematite. Particular preference is given to using very finely divided α-Al₂O₃ nuclei having an average particle size of less than 0.1 μm. In general, from 2 to 3% by weight of nuclei, based on the aluminum oxide formed, is sufficient.

This starting solution additionally contains oxides formers to produce the oxides MeO in the mixed oxide. Possibilities here are, in particular, the chlorides of the elements of main groups I and II of the Periodic Table, in particular the chlorides of the elements Ca and Mg, but also other soluble or dispersible salts such as oxides, oxychlorides, carbonates or sulfates. The amount of oxide formers is calculated so that the finished nanoparticles contain from 0.01 to 50% by weight of the oxide MeO. The oxides of main groups I and II can be present as a separate phase in addition to the aluminum oxide or form genuine mixed oxides with this, e.g. spinels, etc. For the purposes of the present invention, the term “mixed oxides” encompasses both types.

This suspension of aluminum chlorohydrate, nuclei and oxide formers is then evaporated to dryness and subjected to heat treatment (calcination). This calcination is carried out in apparatuses suitable for this purpose, for example in push-through, chamber, tube, rotary tube or microwave furnaces or in a fluidized-bed reactor. In one variant of the process of the invention, the aqueous suspension of aluminum chlorohydrate, oxide formers and nuclei can be sprayed without prior removal of water directly into the calcination apparatus.

The temperature for the calcination should not exceed 1400° C. The lower temperature limit is dependent on the desired yield of nanocrystalline mixed oxide, on the desired residual chlorine content and on the content of nuclei. The formation of the nanoparticles commences at about 500° C., but to keep the chlorine content low and the yield of nanoparticles high, preference is given to temperatures of from 700 to 1100° C., in particular from 1000 to 1100° C.

It has surprisingly been found that from 0.5 to 30 minutes, preferably from 0.5 to 10 minutes, in particular from 2 to 5 minutes, generally suffice for the calcination. Even after this short time, a satisfactory yield of nanoparticles can be achieved under the abovementioned conditions for the preferred temperatures. However, it is also possible to calcine for 4 hours at 700° C. or for 8 hours at 500° C. as described in Ber. DKG 74 (1997) No. 11/12, pp. 722.

Agglomerates in the form of virtually spherical nanoparticles are obtained in the calcination. These particles comprise Al₂O₃ and MeO. The content of MeO acts as an inhibitor for crystal growth and keeps the crystallite size small. The agglomerates as are obtained by the above-described calcination thus differ significantly from the particles as are used in the process described in WO 2004/069 400 where the particles are relatively coarse, intrinsically homogeneous particles and not agglomerates of preformed nanoparticles.

To obtain nanoparticles, the agglomerates are preferably comminuted by wet milling in a solvent, for example in an attritor mill, bead mill or stirred mill. This gives mixed oxide nanoparticles which have a crystalline size of less than 1 μm, preferably less than 0.2 μm, particularly preferably in the range from 0.001 to 0.9 μm. In this way, for example, a suspension of nanoparticles having a d90 of about 50 nm is obtained after milling for six hours. Another possibility for deagglomeration is treatment with ultrasound.

There are two possibilities for the modification according to the invention of the surface of these nanoparticles by means of coating agents, e.g. silanes or siloxanes. In a first preferred variant, the deagglomeration can be carried out in the presence of the coating agent, for example by introducing the coating agent into the mill during milling. A second possibility is firstly to destroy the agglomerates of the nanoparticles and subsequently treat the nanoparticles, preferably in the form of a suspension in a solvent, with the coating agent.

Possible solvents for the deagglomeration include both water and customary solvents, preferably ones which are also employed in the surface coatings industry, for example C₁-C₄-alcohols, in particular methanol, ethanol or isopropanol, acetone, tetrahydrofuran, butyl acetate. If the deagglomeration is carried out in water, and inorganic or organic acid, for example HCl, HNO₃, formic acid or acetic acid, should be added to stabilize the resulting nanoparticles in the aqueous suspension. The amount of acid can be from 0.1 to 5% by weight, based on the mixed oxide. The particle size fraction having a particle diameter of less than 20 nm is then preferably separated off from this aqueous suspension of the acid-modified nanoparticles by centrifugation. The coating agent, preferably a silane or siloxane, is subsequently added at elevated temperature, for example about 100° C. The nanoparticles which have been treated in this way precipitate, are separated off and dried to give a powder, for example by freeze drying.

Suitable coating agents are preferably silanes or siloxanes or mixtures thereof.

Furthermore, all materials which can bind physically to the surface of the mixed oxides (adsorption) or can bind to the surface of the mixed oxide particles by formation of a chemical bond are also suitable as coating agents. Since the surface of the mixed oxide particles is hydrophilic and free hydroxy groups are available, possible coating agents are alcohols, compounds having amino, hydroxy, carbonyl, carboxyl or mercapto functions, silanes or siloxanes. Examples of such coating agents are polyvinyl alcohol, monocarboxylic, dicarboxylic and tricarboxylic acids, amino acids, amines, waxes, surfactants, hydroxycarboxylic acids, organosilanes and organosiloxanes.

Possible silanes and siloxanes are compounds of the formulae

a) R[—Si(R′R″)—O—]ₙ Si(R′R″)-R′″ or cyclo[—Si(R′R″)—O—]ᵣ Si(R′R″)—O—

where

R, R′, R″, R′″ are identical or different and are each an alkyl radical having 1-18 carbon atoms or a phenyl radical or an alkylphenyl or phenylalkyl radical having 6-18 carbon atoms or a radical of the formula —(CₘH₂ₘ—O)ₚ—C_{q}H_{2q+1} or a radical of the formula —CₛH₂ₛY or a radical of the formula —XZₜ₋₁,

n is an integer such that 1≦n≦1000 preferably 1≦n≦100,

m is an integer such that 0≦m≦12 and

p is an integer such that 0≦p≦60 and

q is an integer such that 0≦q≦40 and

r is an integer such that 2≦r≦10 and

s is an integer such that 0≦s≦18 and

Y is a reactive group, for example an α,β-ethylenically unsaturated group such as a (meth)acryloyl, vinyl or allyl group, an amino, amido, ureido, hydroxyl, epoxy, isocyanato, mercapto, sulfonyl, phosphonyl, trialkoxysilyl, alkyldialkoxysilyl, dialkylmonoalkoxysilyl, anhydride and/or carboxyl group, an imido, imino, sulfite, sulfate, sulfonate, phosphine, phosphite, phosphate, phosphonate group, and

X is a t-functional oligomer where

t is an integer such that 2≦t≦8, and

z is in turn a radical
R[Si(R′R″)—O—]ₙSi(R′R″)—R′″ or cyclo[Si(R′R″)—O—]ᵣSi(R′R″)—O— as defined above.

The t-functional oligomer X is preferably selected from among:

oligoethers, oligoesters, oligoamides, oligourethanes, oligoureas, oligo-olefins, oligovinyl halides, oligovinylidene dihalides, oligoimines, oligovinyl alcohol, esters, acetals and ethers of oligovinyl alcohol, cooligomers of maleic anhydride, oligomers of (meth)acrylic acid, oligomers of (meth)acrylic esters, oligomers of (meth)acrylamides, oligomers of (meth)acrylimides, oligomers of (meth)acrylonitrile, particularly preferably oligoethers, oligoesters, oligourethanes.

Examples of radicals of oligoethers are compounds of the type —(CₐH₂ₐ—O)_{b}—CₐH₂ₐ— or O—(CₐH₂ₐ—O)_{b}—CₐH₂ₐ—O where 2≦a≦12 and 1≦b≦60, e.g. a diethylene glycol, triethylene glycol or tetraethylene glycol radical, a dipropylene glycol, tripropylene glycol, tetrapropylene glycol radical, a dibutylene glycol, tributylene glycol or tetrabutylene glycol radical. Examples of radicals of oligoesters are compounds of the type —C_{b}H_{2b}—(C(CO)CₐH₂ₐ—(CO)O—C_{b}H_{2b}—)_{c}— or —O—C_{b}H_{2b}—(C(CO)CₐH₂ₐ—(CO)O—C_{b}H_{2b}—)_{c}—O— where a and b are identical or different and 3≦a≦12, 3≦b≦b≦12 and 1≦c≦30, e.g. an oligoester of hexanediol and adipic acid,

b) organosilanes of the type (RO)₃Si(CH₂)_{M}—R′

where

R′=alkyl such as methyl, ethyl, propyl,

m=0.1-20,

R′=methyl, phenyl,
—C₄F₉; OCF₂—CHF—CF₃, —C₆F₁₃, —O—CF₂—CHF₂
—NH₂, —N₃, SCN, —CH═CH₂, —NH—CH₂—CH₂—NH₂,
—N—(CH₂—CH₂—NH₂)₂
—OOC(CH₃)C═CH₂
—OCH₂—CH(O)CH₂
—NH—CO—N—CO—(CH₂)₅
—NH—COO—CH₃, —NH—COO—CH₂CH₃, —NH—(CH₂)₃Si(OR)₃
—Sₓ—(CH₂)₃)Si(OR)₃
—SH
—NR′R″R′″(R′=alkyl, phenyl; R″=alkyl, phenyl; R′″=H, alkyl, phenyl, benzyl
C₂H₄NR″″ where R″″=A, alkyl and R′″″=H, alkyl).

Examples of silanes of the abovementioned type are hexamethyldisiloxane, octamethyltrisiloxane, further homologous and isomeric compounds of the series SiₙOₙ₋₁(CH₃)₂ₙ₊₂, where

n is an integer such that 2≦n≦1000, e.g. polydimethylsiloxane 200® fluid (20 cSt).

Hexamethylcyclotrisiloxane, octamethylcyclotetrasiloxane, further homologous and isomeric compounds of the series (Si—O)ᵣ(CH₃)₂ᵣ, where

r is an integer such that 3≦r≦12,

dihydroxytetramethyldisiloxane, dihydroxyhexamethyltrisiloxane, dihydroxy-octamethyltetrasiloxane, further homologous and isomeric compounds of the series

HO-[(Si—O)ₙ(CH₃)₂ₙ]—Si(CH₃)₂—OH or

HO—[(Si—O),(CH₃)₂ₙ]—[Si—O)ₘ(C₆H₅)₂ₘ]—Si(CH₃)₂—OH, where

m is an integer such that 2≦m≦1000,

preferably the α,ω-dihydroxypolysiloxanes, e.g. polydimethylsiloxane (OH end groups, 90-150 cSt) or polydimethylsiloxane-co-diphenylsiloxane (dihydroxy end groups, 60 cSt),

dihydrohexamethyltrisiloxane, dihydrooctamethyltetrasiloxane, further homologous and isomeric compounds of the series

H—[(Si—O)ₙ(CH₃)₂ₙ]—Si(CH₃)₂—H, where

n is an integer such that 2≦n≦1000, preferably the α,ω-dihydro-polysiloxanes, e.g. polydimethylsiloxane (hydride end groups, Mₙ=580), di(hydroxypropyl)hexamethyltrisiloxane, di(hydroxypropyl)octamethyl-tetrasiloxane, further homologous and isomeric compounds of the series HO—(CH₂)ᵤ[Si—O),(CH₃)₂(CH₂)ᵤ—OH, preferably the α,ω-dicarbinolpoly-siloxanes where 3≦u≦18, 3≦n≦1000 or their polyether-modified derivatives based on ethylene oxide (EO) and propylene oxide (PO) as homopolymers or copolymers HO—(EO/PO)ᵥ—(CH₂)ᵤ[Si—O)ₜ(CH₃)₂ₜ]—Si(CH₃)₂(CH₂)ᵤ-(EO/PO)ᵥ—OH, preferably α,ω)-di(carbinol polyether)poly-siloxanes where 3≦n≦1000, 3≦u≦18, 1≦v≦50.

Instead of α,ω-OH groups, it is likewise possible to use the corresponding bifunctional compounds bearing epoxy, isocyanato, vinyl, allyl and di(meth)acryloyl groups, polydimethylsiloxane having vinyl end groups (850-1150 cSt) or TEGORAD 2500 from Tego Chemie Service.

Further possibilities are the esterification products of ethoxylated/propoxylated trisiloxanes and higher siloxanes having acrylic acid copolymers and/or maleic acid copolymers as modifying compounds, e.g. BYK Silclean 3700 from Byk Chemie or TEGOO Protect 5001 from Tego Chemie Service GmbH.

Instead of 60 ,ω-OH groups, it is likewise possible to use the corresponding bifunctional compounds bearing —NHR″″ where R″″=H or alkyl, e.g. the generally known amino silicone oils from Wacker, Dow Corning, Bayer, Rhodia, etc., which bear randomly distributed (cyclo)alkylamino groups or (cyclo)alkylimino groups on their polysiloxane chain.

c) organosilanes of the type (RO)₃Si(CnH₂ₙ₊₁) and (RO)₃Si(CₙH₂ₙ₊₁), where

R is an alkyl such as methyl, ethyl, n-propyl, i-propyl, butyl,

n is from 1 to 20,

organosilanes of the type R′x(RO)ySi(CnH2n+1) and (RO)3Si(CnH2n+1), where

R is an alkyl such as methyl, ethyl, n-propyl, i-propyl, butyl,

R″ is an alkyl such as methyl, ethyl, n-propyl, i-propyl, butyl,

R″ is a cycloalkyl,

n is an integer in the range 1-20,

x+y=3,

x is 1 or 2,

y is 1 or 2,

organosilanes of the type (RO)₃Si(CH₂)ₘ-R′, where

R is an alkyl such as methyl, ethyl, propyl,

m is in the range 0.1-20,

R′ is methyl, phenyl, —C₄F₉; OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C═CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH—NR′R″R′″ (R′=alkyl, phenyl;

R″ is alkyl, phenyl; R′″=H, alkyl, phenyl, benzyl, C₂H₄N″″″R′″″ where R″″=A, alkyl and R′″″=H, alkyl).

Preferred silanes are the silanes listed below: triethoxysilane, octadecyltrimethoxysilane, 3-(trimethoxysilyl)propyl methacrylate, 3-(trimethoxysilyl)propyl acrylate, 3-(trimethoxysilyl)methyl methacrylate, 3-(trimethoxysilyl)methyl acrylate, 3-(trimethoxysilyl)ethyl methacrylate, 3-(trimethoxysilyl)ethyl acrylate, 3-(trimethoxysilyl)pentyl methacrylate, 3-(trimethoxysilyl)pentyl acrylate, 3-(trimethoxysilyl)hexyl methacrylate, 3-(trimethoxysilyl)hexyl acrylate, 3-(trimethoxysilyl)butyl methacrylate, 3-(trimethoxysilyl)butyl acrylate, 3-(trimethoxysilyl)heptyl methacrylate, 3-(trimethoxysilyl)heptyl acrylate, 3-(trimethoxysilyl)octyl methacrylate, 3-(trimethoxysilyl)octyl acrylate, methyltrimethoxysilane, methyltriethoxysilane, propyltrimethoxysilane, propyltriethoxysilane, isobutyltrimethoxysilane, isobutyltriethoxysilane, octyltrimethoxysilane, octyltriethoxysilane, hexadecyltrimethoxysilane, phenyltrimethoxysilane, phenyltriethoxysilane, tridecafluoro-1,1,2,2-tetrahydrooctyltriethoxysilane, tetramethoxysilane, tetraethoxysilane, oligomeric tetraethoxysilane (DYNASIL® 40 from Degussa), tetra-n-propoxysilane, 3-glycidyloxypropyl-trimethoxysilane, 3-glycidyloxypropyltriethoxysilane, 3-methacryloxypropyl-trimethoxysilane, vinyltrimethoxysilane, vinyltriethoxysilane, 3-mercapto-propyltrimethoxysilane, 3-aminopropyltriethoxysilane, 3-aminopropyltri-methoxysilane, 2-aminoethyl-3-aminopropyltrimethoxysilane, triamino-functional propyltrimethoxysilane (DYNASYLAN® TRIAMINO from Degussa), N-(n-butyl-3-aminopropyltrimethoxysilane, 3-aminopropyl-methyldiethoxysilane.

The coating agents, here in particular the silanes or siloxanes, are preferably added in molar ratios of mixed oxide nanoparticles to silane of from 1:1 to 10:1. The amount of solvent in the deagglomeration is generally from 80 to 90% by weight, based on the total amount of mixed oxide nanoparticles and solvent.

The deagglomeration by milling and simultaneous modification by means of the coating agent is preferably carried out at temperatures of from 20 to 150° C., particularly preferably from 20 to 90° C.

If deagglomeration is effected by milling, the suspension is subsequently separated off from the milling media.

After deagglomeration, the suspension can be heated for a further period of up to 30 hours to complete the reaction. The solvent is subsequently distilled off and the residue which remains is dried. It can also be advantageous to leave the modified mixed oxide nanoparticles in the solvent and use the dispersion for further applications.

It is also possible to suspend the mixed oxide nanoparticles in the appropriate solvents and carry out the reaction with the coating agent in a further step after the deagglomeration.

The mixed oxide nanoparticles which have been produced in this way and modified by means of coating agents can be incorporated into transparent varnishes or surface coatings, resulting in improved scratch resistance. As a result of the modification by means of the coating agents, the mixed oxide nanoparticles can be dispersed without problems in nonaqueous systems. Furthermore, the coatings display reduced clouding compared to layers which contain unmodified nanoparticles.

### EXAMPLES

### Example 1

A 50% strength aqueous solution of aluminum chlorohydrate was admixed with magnesium chloride so that the ratio of aluminum oxide to magnesium oxide after calcination was 99.5:0.5%. In addition, 2% of crystallization nuclei as a suspension of very fine α-alumina were added to the solution. After the solution had been homogenized by stirring, it was dried in a rotary evaporator. The solid aluminum chlorohydrate/magnesium chloride mixture was comminuted in a mortar to give a coarse powder.

The powder was calcined at 1050° C. in a rotary tube furnace. The contact time in the hot zone was not more than 5 minutes. This gave a white powder whose particle size distribution corresponded to the material introduced.

X-ray structure analysis shows that predominantly α-aluminum oxide is present.

The SEM (scanning electron microscope) images showed crystallites in the range 10-80 nm (estimation from the SEM scanning electron micrograph) which were present as agglomerates. The residual chlorine content was only a few ppm.

In a further step, 40 g of this ax-alumina powder doped with magnesium oxide were suspended in 160 g of isopropanol. 40 g of trimethoxyoctyl-silane were added to the suspension and the mixture was fed into a vertical stirred ball mill from Netzsch (model PE 075). The milling media used comprised zirconium oxide (stabilized with yttrium) and had a size of 0.3 mm. After three hours, the suspension was separated off from the milling media and refluxed for a further 4 hours. The solvent was subsequently distilled off and the moist residue which remained was dried at 110° C. for a further 20 hours in a drying oven.

### Example 2

40 g of the oxide mixture (α-alumina doped with MgO) from example 1 was suspended in 160 g of methanol and deagglomerated in a vertical stirred ball mill from Netzsch (model PE 075). After 3 hours, the suspension was separated off from the milling media and transferred to a round-bottom flask provided with a reflux condenser. 40 g of trimethoxyoctylsilane were added to the suspension and the mixture was refluxed for 2 hours. After removal of the solvent, the coated oxide mixture was isolated and dried at 110° C. in a drying oven for a further 20 hours. The product obtained in this way is identical to the sample from example 1.

### Example 3

40 g of the oxide mixture (α-alumina doped with MgO) from example 1 were suspended in 160 g of methanol and deagglomerated in a vertical stirred ball mill from Netzsch (model PE 075). After 2 hours, 20 g of 3-(trimethoxysilyl)propyl methacrylate (Dynasilan Memo; Degussa) were added and the suspension was deagglomerated in the stirred ball mill for a further 2 hours. The suspension was subsequently separated off from the milling media and transferred to a round-bottom flask provided with a reflux condenser. The suspension was refluxed for a further 2 hours before the solvent was distilled off.

### Example 4

40 g of the oxide mixture (α-alumina doped with MgO) from example 1 were suspended in 160 g of acetone and deagglomerated in a vertical stirred ball mill from Netzsch (model PE 075). After 2 hours, 20 g of aminopropyltrimethoxysilane (Dynasilan Ammo; Degussa) were added and the suspension was deagglomerated in the stirred ball mill for a further 2 hours. The suspension was subsequently separated off from the milling media and transferred to a round-bottom flask provided with a reflux condenser. The suspension was refluxed for a further 2 hours before the solvent was distilled off.

### Example 5

40 g of the oxide mixture (α-alumina doped with MgO) from example 1 were suspended in 160 g of acetone and deagglomerated in a vertical stirred ball mill from Netzsch (model PE 075). After 2 hours, 20 g of glycidyltrimethoxysilane (Dynasilan Glymo; Degussa) were added and the suspension was deagglomerated in the stirred ball mill for a further 2 hours.

The suspension was subsequently separated off from the milling media and transferred to a round-bottom flask provided with a reflux condenser. The suspension was refluxed for a further 2 hours before the solvent was distilled off.

### Example 6

40 g of the oxide mixture (α-alumina doped with MgO) from example 1 were suspended in 160 g of n-butanol and deagglomerated in a vertical stirred ball mill from Netzsch (model PE 075). After 2 hours, a mixture of 5 g of aminopropyltrimethoxysilane (Dynasilan Glymo; Degussa) and 15 g of octyltriethoxysilane was added and the suspension was deagglomerated in the stirred ball mill for a further 2 hours. The suspension remains stable over a period of weeks without signs of sedimentation of the coated mixed oxide.

1. A surface modified nanoparticle comprising 50-99.9% by weight of aluminum oxide predominantly in the rhombohedral α modification and 0.1-50% by weight of at least one oxide of at least one element of main groups I and II of the Periodic Table, wherein the surface of the nanoparticle is modified by a coating agent.

2. A surface modified nanoparticle as claimed in claim 1, wherein the coating agent is a siloxane or silane.

3. A surface modified nanoparticle as claimed in claim 1, wherein the mixed oxides have a crystallite size of less than 1 μm.

4. A process for producing the surface modified nanoparticle as claimed in claim 1, comprising the steps of deagglomerating the agglomerates of the nanoparticles in the presence of an organic solvent by milling and simultaneously or subsequently treating the nanoparticle with a coating agent.

5. The process as claimed in claim 4, wherein the deagglomerating step is performed by milling in a stirred ball mill.

6. The process as claimed in claim 4, wherein the deagglomerating step is performed by milling at from 20 to

7. The process as claimed in claim 4, wherein the deagglomerating step is carried out in a C₁-C₄-alcohol as solvent.

8. The process as claimed in claim 4, wherein the deagglomerating step is carried out in acetone, tetrahydrofuran, butyl acetate or other solvents used in the surface coatings industry.

9. The process as claimed in claim 4, wherein the molar ratio of nanoparticles to coating agent is from 1:1 to 10:1.

10. A surface-modified nanoparticle as claimed in claim 1, wherein the mixed oxides have a crystallite size of less than 0.2 μm.

11. A surface-modified nanoparticle as claimed in claim 1, wherein the mixed oxides have a crystallite size in the range from 0.001 μm to 0.1 μm.

12. A process as claimed in claim 4, wherein the coating agent is a silane, a siloxane or mixture thereof.
